(19) United States
(12) Patent Application Publication
(10) Pub. No.: US 2008/0034028 A1
(43) Pub. Date: Feb. 7, 2008

(54) System and method to provide an advertisement dragging system

(76) Inventors: Terry L. Ferrell, The Colony, TX (US); Robert V. Byron, Plano, TX (US)

Correspondence Address: JACKSON WALKER LLP, 901 MAIN STREET, SUITE 6000, DALLAS, TX, 75202-3797, US

(21) Appl. No.: 11/890,092

(22) Filed: Aug. 3, 2007

Related U.S. Application Data
(60) Provisional application No. 60/835,346, filed on Aug. 3, 2006.
(60) Provisional application No. 60/846,052, filed on Sep. 20, 2006.
(60) Provisional application No. 60/835,348, filed on Aug. 3, 2006.
(60) Provisional application No. 60/835,347, filed on Aug. 3, 2006.

(51) Int. Cl. G06F 15/16

(52) U.S. Cl. 709/201

(57) ABSTRACT

A system and method for providing an advertisement dragging system. A user is authorized to use a set of internet-based tools by logging into a website, where a set of internet utilization enhancement tools are available on a screen having several different regions. When the user does a search for a product or service, a set of advertisements provided by vendors selling products or services associated to the search term will appear on the screen. The selected advertisements can then be moved to another region of the screen where a longer and complete advertisement including video and/or sound can be played. If the user elects to play the advertisement, the advertiser may wish to reward the user with a special inducement to make a purchase, such as a coupon.

### PRIORITY CLAIM

This application claims priority to U.S. Provisional Patent Application Ser. No. 60/835,346, entitled “ADVERTISEMENT DRAGGING SYSTEM” filed Aug. 3, 2006 and U.S. Provisional Patent Application Ser. No. 60/835,347, entitled “DRAG AND DROP SEARCH RESULTS” filed Aug. 3, 2006, U.S. Provisional Patent Application Ser. No. 60/835,348, entitled “ENHANCED THUMB DRIVE COMMUNICATION SYSTEM,” filed Aug. 3, 2006, and U.S. Provisional Patent Application Ser. No. 60/846,052, entitled “CONFIGURABLE DESKTOP” filed Sep. 20, 2006, each of which are hereby incorporated herein by reference for all purposes.

### FIELD OF THE INVENTION

The present invention pertains to Internet communication, and more particularly to enhancing the utility of Internet communication.

### BACKGROUND OF THE INVENTION

The utility of the Internet is limited by the tools provided to Internet users. This limitation is particularly apparent in bringing buyers together with sellers. For example, if a buyer is searching for a particular product or service, a search is done. If the search request is broad, the potential buyer may receive so many hits in response to the search request that time or interest will not permit a review of all of the hits found by the potential buyer. Accordingly, the product or service sought by the potential buyer may be available but the potential buyer simply was not able to find it. For a potential seller, this results in a lost sale.

On the seller side, advertisements are crafted to send a message about the seller's product/service which demonstrates the unique features of a product/service in a succinct form which conveys the maximum amount of information to a potential buyer in the minimum amount of time, but the cost associated with providing such advertisements limits the ability of sellers to reach potential buyers. As a result, it is often the seller that spends the most money on advertising that reaches potential buyers, regardless of whether the advertisement addresses the goods or services that the buyer is interested in purchasing.

### SUMMARY OF INVENTION

The present invention achieves technical advantages as a system and method for providing an advertisement dragging system. In one exemplary embodiment of the present invention, a set of Internet-based tools are provided on a screen having several predetermined regions. When the user searches for a product or service, a set of advertisements, provided by vendors selling products or services associated to the search term, will appear on the screen in one of the predetermined regions. A selected indicia can then be moved to another region of the screen where a longer and complete advertisement, such as including video or sound, can be played.

### BRIEF DESCRIPTION OF THE DRAWINGS

FIG. 1 is a diagram of a computer screen, wherein a set of enhanced internet utilization tools for providing advertisements are available, in accordance with an exemplary embodiment of the present invention;

FIG. 2 is a diagram of a computer screen, wherein an advertisement that has been selected for review and a purchase inducement is rendered on the computer screen, in accordance with an exemplary embodiment of the present invention;

FIG. 3 is a diagram of a removable storage drive system in accordance with an exemplary embodiment of the present invention; and

FIG. 4 is a diagram of a system for creating a personal virtual desktop in accordance with an exemplary embodiment of the present invention.

### DETAILED DESCRIPTION OF THE PRESENT INVENTION

Advertisements are most effective when conveyed to a potential buyer when the potential buyer effectively has money in hand and is ready to make a purchase. The present invention enhances the utility of Internet communications so that an advertisement for a product/service is placed before the potential buyer when the potential buyer has indicated a desire and a willingness to make a purchase.

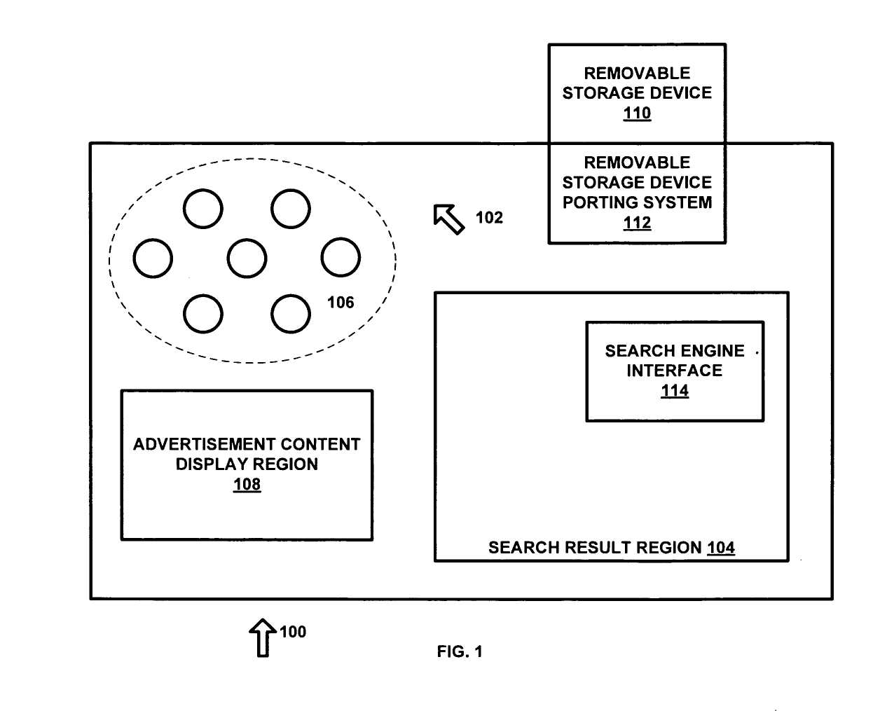

Referring to FIG. 1, there is shown system 100, which includes a computer screen wherein a set of enhanced Internet utilization tools for providing advertisements are available, in accordance with an exemplary embodiment of the present invention. System 100 includes selection device 102, search result region 104, search-term-related advertisement region 106, advertisement content display region 108, removable storage device 110 removable storage device porting system 112, and search engine interface 114, each of which can be implemented in hardware, software, or a suitable combination of hardware and software, and which can be one or more software systems operating on a digital signal processing platform, a general purpose processing platform, or other suitable processing platforms. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

Selection device 102 can be a cursor, arrow, or other icon controllable with a computer mouse, or other suitable selection devices. A user can log into the environment using a web browser with Internet connectivity. Advertisements can be rendered in search-term-related advertisement region 106, such as in response to calculations performed by the website host in response to search terms entered by the user, based on a predetermined priority, or in other suitable manners. Advertisement content display region 108 can contain the website host's logo as well as other suitable information. The user enters a search term and performs a search in search result region 104, such as by using search engine interface 114, which can interface to a proprietary search engine, third-party search engines, or other suitable search engines. Search results for the search term are displayed in search result region 104. Advertisements associated with the search term are displayed in search-term-related advertisement region 106. The user, if interested, can elect to view a more robust advertisement, which can include video content, in advertisement content display region 108. The user can select which advertisement to view, and with selection device 102, drag the selected advertisement onto advertisement content display region 108. The advertisement is then viewable in advertisement content display region 108. The dragging of the advertisement from search-term-related-advertisement region 106 onto advertisement content display region 108 can be achieved with an application programming interface (API), HTML, DHTML, JavaScript, other suitable applications, or a suitable combination thereof.

Removable storage device 110 can be a suitable removable storage device, such as a USB port “thumb” drive, a ROM storage card, or other suitable removable storage devices. Removable storage device porting system 112 can be a suitable port for removable storage device 110, such as a USB port, a ROM storage card interface device, or other suitable devices. System 100 allows a user to click and drag the search results, advertising content, or other suitable data for storage on removable storage device 110.

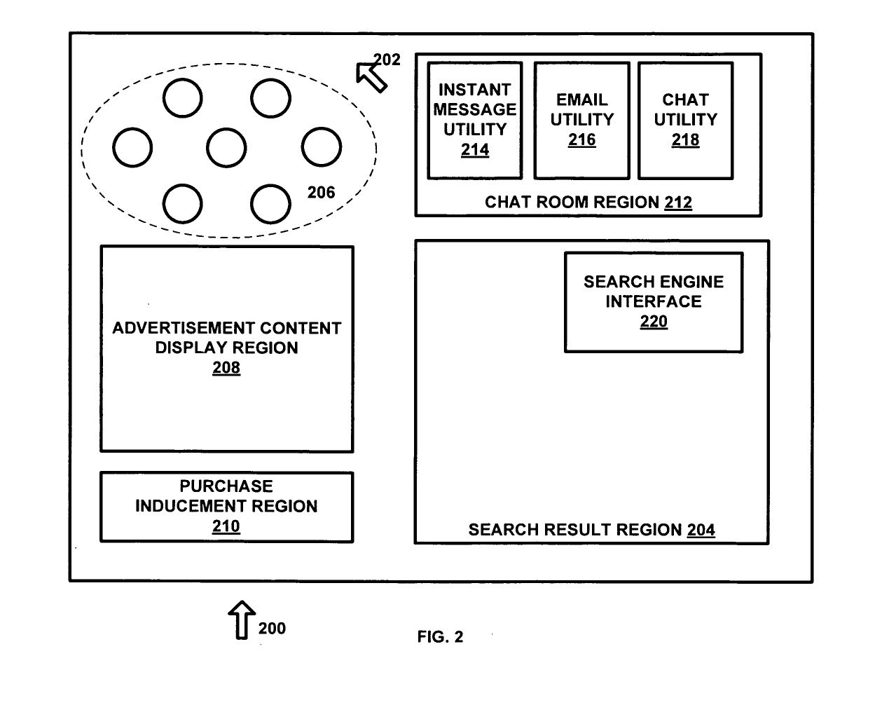

Now referring to FIG. 2, there is shown a system 200 including a diagram of a computer screen, wherein an advertisement has been selected for review and a corresponding purchase inducement is rendered on the computer screen, in accordance with an exemplary embodiment of the present invention. System 200 includes selection device 202, search result region 204, search-term-related advertisement region 206, advertisement content display region 208, purchase inducement region 210, chat room region 212, instant message utility 214, email utility 216, chat utility 218 and search engine interface 220, each of which can be implemented in hardware, software, or a suitable combination of hardware and software, and which can be one or more software systems operating on a digital signal processing platform, a general purpose processing platform, or other suitable platforms. Selection device 202 can be a cursor, arrow, or other icon controllable with a computer mouse. After the user selects an advertisement to view from search-term-related advertisement region 206 and drags the selected advertisement onto advertisement content display region 208 with selection device 202, an advertiser associated with the advertisement can reward the user with a special inducement to make a purchase. The inducement can be displayed in purchase inducement region 210 and can be viewed and downloaded by the user. In one exemplary embodiment, the purchase inducement can be a coupon with a bar code. In another exemplary embodiment, the purchase inducement can be a coupon text string code for use on the advertiser's website. The rendering of the purchase inducement in purchase inducement region 210 can be achieved with an application programming interface (API), HTML, DHTML, JavaScript, other suitable applications, or a suitable combination thereof. In another exemplary embodiment, the purchase inducement can be stored on removable storage device 110 and can be physically transported to a store, so as to allow a user to obtain purchase inducements and to view the related product or service at a store before making a purchase decision.

If the user has a mobile electronic device with storage and Internet capability, the coupon can be transmitted and stored on the electronic device. When the user visits a store to actually buy the chosen product or service, the coupon on the electronic device can be used to obtain a discount on the product or service, or possibly obtain another product/service related to the product/service being purchased.

The present invention achieves technical advantages by rendering the purchase inducement related to an advertisement linked to a search term to the user. Also, by harnessing the simplicity of drag and drop functionality into a search engine environment, the result is a highly intuitive, easy to use utility.

A second user identified in chat room region 212 can be selected to send search results returned from a search engine, such as through search engine interface 220 which interfaces to a proprietary search engine, a third party search engine, or other suitable search engines. The results displayed in search result region 204 can be transmitted by dragging search result region 204 or selections from search result region 204 with selection device 202 onto a specific user in chat room region 212 intended to receive the search results. The dragging of search result region 204 into chat room region 212 can be achieved with an application programming interface (API), HTML, DHTML, JavaScript, other suitable applications, or a suitable combination thereof.

The second user receives a message from the first user in chat room region 212, while search result region 204 is automatically opened and populated with the contents of the search results sent by the first user, or selections thereof.

In one exemplary embodiment, a first and a second user log into a website server, where a set of Internet utilization enhancement tools are available. The first and the second user can exchange messages in chat room region 212, such as by using instant message utility 214, email utility 216, chat utility 218 (such as by using Voice over Internet Protocol or other suitable functionality), by posting of messages within chat room region 212, or in other suitable manners. After one user enters a search term into a search engine located in search result region 204, search results are returned to the user in search result region 204. The user can drag and drop search result region 204 or individual search results from search result region 204 into chat room region 212, where communication between the first and the second user is in progress. The other user can receive the specific search results provided by the user that performed the search, such as by using an instant message utility 214, an email utility 216, a chat utility 218, by posting of messages within chat room region 212, or in other suitable manners. Advantageously, the user receiving the search results will not have to replicate the search in order to view the same search term results displayed to the user that performed the search. Search result region 204 for the other user can also or alternatively be launched with the search results for the search term already loaded by the user that performed the search.

In another exemplary embodiment, a user can order office supplies, such as where permission from a supervisor is needed before the order can be placed. The order form can be filled out by the user and dragged to chat room region 212, where the supervisor is logged on and available to chat. The supervisor can then open, review, and approve the order. Once approved, the supervisor can drag the order into chat room region 212 where a vendor is logged on, so as to allow the vendor to receive the order.

In another exemplary embodiment, users communicating in chat room region 212 can drag a text document or an image, such as a coupon with a bar code, into the chat room region and send the item to one-another.

The present invention achieves further technical advantages by eliminating typing and application manipulation in order to send search term results to a receiving user. By harnessing the simplicity of drag and drop functionality into a chat room environment, the result is a highly intuitive, easy to use environment.

The present invention achieves technical advantages as a system and method for enhancing Internet-based communication by enabling Internet search results to be combined with a chat room region with an Internet-based communication application. In one exemplary embodiment of the present invention, a user can use a set of Internet utilization enhancement tools after logging into a system, which allows the user the ability to communicate with another user, and to drag and drop search results into the chat room region for other users to view and manipulate.

The user can utilize a screen including several different regions of Internet utilization enhancement tools to access certain utilities, such as an instant messaging utility 214, an email utility 216, a chat utility 218, or other suitable Internet-based applications, to include searching for information available over the internet.

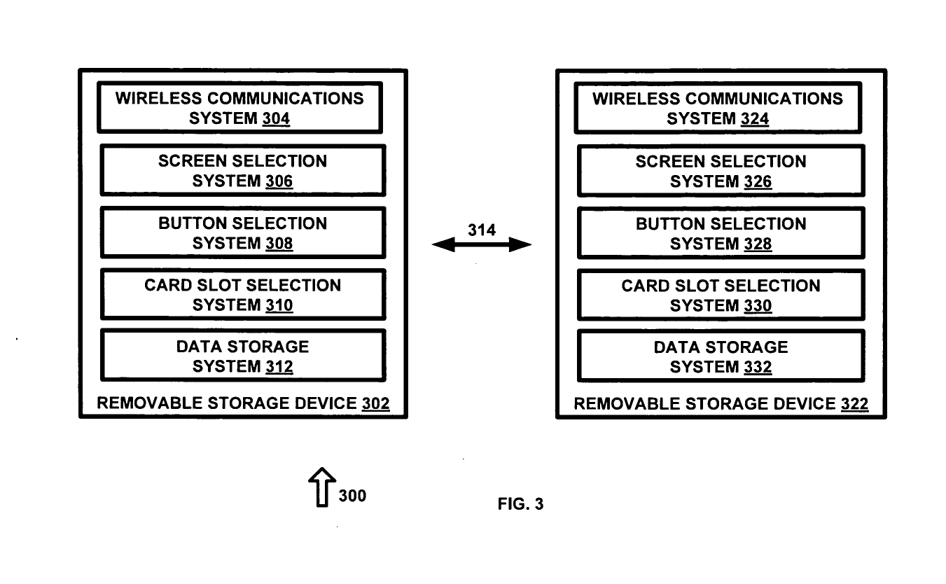

FIG. 3 is a diagram of a removable storage drive system 300 in accordance with an exemplary embodiment of the present invention. Removable storage drive system 300 allows removable storage devices to transfer selected sets of data between removable storage drives, with other computers, or in other suitable manners.

Removable storage drive system 300 includes removable storage drives 302 and 322, which can be USB thumb drives or other suitable devices. Removable storage drives 302 and 322 include wireless communication systems 304 and 324, screen selection systems 306 and 326, button selection systems 308 and 328, card slot selection systems 310 and 330, and data storage systems 312 and 332, respectively, each of which can be implemented in hardware, software, or a suitable combination of hardware and software.

Wireless communication systems 304 and 324 allow removable storage drives 302 and 322, respectively, to wirelessly transmit information, so as to eliminate the need for removable storage drives 302 and 322 to physically interface to communicate data. In one exemplary embodiment, wireless communication systems 304 and 324 can be used to transmit data to a general purpose computing platform, such as where removable storage drive 302 or 322 contains purchase inducement data obtained using system 200 and the user has taken removable storage drive 302 or 322 to a store and desires to use the purchase inducement data to make a purchase. In another exemplary embodiment, users of removable storage drives 302 and 322 can exchange data between removable storage drives 302 and 322 using wireless communication systems 304 and 324, where such data is selected using screen selection systems 306 and 326, button selection systems 308 and 328, or card slot selection systems 310 and 330, respectively.

Screen selection systems 306 and 326 allow data to be selected for transmission between removable storage drives 302 and 322 or other suitable systems. In one exemplary embodiment, purchase inducement data can be selected using screen selection systems 306 or 326 to allow a user of removable storage drive 302 or 322, respectively, to transmit the purchase inducement to a system at a store so as to receive a discount or other purchase inducement. In another exemplary embodiment, users of removable storage drives 302 and 322 can select data to be transmitted or received between removable storage drives 302 and 322 using screen selection systems 306 and 326, respectively. In this exemplary embodiment, a user of removable storage drive 302 can use screen selection system 306 to select data for transmission to removable storage drive 322, such as a single file, a collection of files, a folder, or other suitable data. Likewise, the user of removable storage drive 322 can use screen selection system 326 to select data for receipt, a location for storage of the data, or other suitable functions.

Button selection systems 308 and 328 allow data to be selected for transmission between removable storage drives 302 and 322 or other suitable systems. In one exemplary embodiment, purchase inducement data can be selected using button selection systems 308 and 328 to allow a user of removable storage drive 302 or 322, respectively, to transmit the purchase inducement to a system at a store so as to receive a discount or other purchase inducement. In another exemplary embodiment, users of removable storage drives 302 and 322 can select data to be transmitted or received between removable storage drives 302 and 322 using button selection systems 308 and 328, respectively. In this exemplary embodiment, a user of removable storage drive 302 can use button selection system 308 to select data for transmission to removable storage drive 322, such as a single file, a collection of files, a folder, or other suitable data. Likewise, the user of removable storage drive 322 can use button selection system 328 to select data for receipt, a location for storage of the data, or other suitable functions.

Card slot selection systems 310 and 330 allow data to be selected for transmission between removable storage drives 302 and 322 or other suitable systems, such as by inserting a predetermined card into one of two or more different slots, by inserting one of two or more different cards into a predetermined slot, or in other suitable manners. In one exemplary embodiment, purchase inducement data can be selected using card slot selection systems 310 and 330 to allow a user of removable storage drive 302 or 322, respectively, to transmit the purchase inducement to a system at a store so as to receive a discount or other purchase inducement. In another exemplary embodiment, users of removable storage drives 302 and 322 can select data to be transmitted or received between removable storage drives 302 and 322 using card slot selection systems 310 and 330, respectively. In this exemplary embodiment, a user of removable storage drive 302 can use card slot selection system 310 to select data for transmission to removable storage drive 322, such as a single file, a collection of files, a folder, or other suitable data. Likewise, the user of removable storage drive 322 can use card slot selection system 330 to select data for receipt, a location for storage of the data, or other suitable functions.

Data storage systems 312 and 332 allow users of removable storage drives 302 and 322, respectively, to store data so as to facilitate easy transfer and receipt of data, such as by selection from a screen, a button, a card slot, or in other suitable manners. In one exemplary embodiment, purchase inducement data can be stored in predetermined folders or locations, such as coupons for use at a store, for a type of product, or other suitable data. In another exemplary embodiment, data such as an electronic business card, items of personal interest such as family pictures, or other suitable sets of data can be stored in folders or other locations, such as locations associated with buttons, screen selections, card slots, or other suitable items, so as to facilitate the transmission and receipt of predetermined types or sets of data from or to removable storage drives 302 and 322.

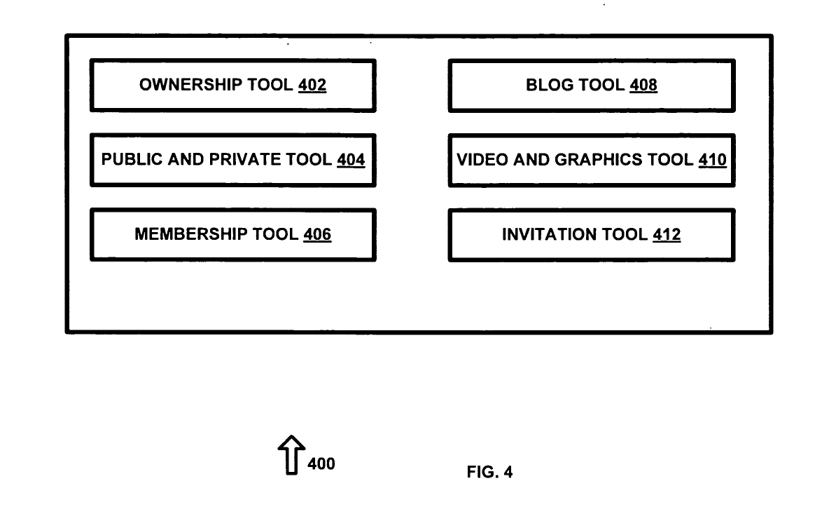

FIG. 4 is a diagram of a system 400 for creating a personal virtual desktop in accordance with an exemplary embodiment of the present invention. System 400 allows a user to customize and construct a personal virtual desktop to facilitate communication with others having a shared or common interest, such as in combination with system 200 or other suitable systems.

Users of social networking websites can elect to be identified or anonymous. In one exemplary embodiment, a user that elects to remain anonymous may be allowed to gain access to a social networking website as a local user.

In one exemplary embodiment, a user of a social networking website creates and configures a personal virtual desktop. The user, using a web browser to access the social networking website, can join the social networking website. During the process of joining the social networking website the user can create, save and have future access to a browser based personal virtual desktop that is persistent for the user.

The configuration of the virtual desktop can persist on the social networking website so that when the main page of the social networking website is accessed, the user customized page would be loaded in place or in combination with a search result region such as search result region 204, each time the user obtains access to the social networking website. In one exemplary embodiment, the virtual desktop tools of system 400 can be used in chat room region 212, in a separate social networking region, or in other suitable regions.

To join the social networking website and create a customized personal virtual desktop, the anonymous user can create an identity that can be used to provide verifiable personal user identification and contact information. For every new user, a default is personal virtual desktop can be provided, which can be modified by the user as desired.

During the creation and modification of personal virtual desktops, the user is provided with a set of tools that is available for inclusion into the personal virtual desktop that gives the personal virtual desktop predetermined functionality. The personal virtual desktop can be configured through the use of tools and each tool or component can control an aspect of the configuration of the personal virtual desktop or a function of the personal virtual desktop.

Ownership tool 402 provides configuration data and storage data that contains the personal information of the user as well as a history of access to the personal virtual desktop by date and time, duration of access and the IP address of the person seeking access to the personal virtual desktop.

Public and private tool 404 controls whether the personal virtual desktop is to be public or private and further controls the privacy policies of the personal virtual desktop. The configuration created as a result of the use of public and private tool 404 can be used to control whether or not the personal virtual desktop is shared or not shared, and to what extent.

Membership tool 406 allows the user to create log ins for others if the personal virtual desktop is made public and other logins for guests if the personal virtual desktop is made private and is only to be shared with predetermined users. If the private virtual desktop is made private and not to be shared with others then logins can be blocked.

Blog tool 408 can include a graphics based text editor to be used for the creation of web logs. In one exemplary embodiment, if the personal virtual desktop is private, the web log created by blog tool 408 can be local. In another exemplary embodiment, when the personal virtual desktop is public, access can be given to the public. Likewise, the web log can also be made searchable using blog tool 408.

Video and graphics tool 410 allows a user to import video or graphics files into the personal virtual desktop. In one exemplary embodiment, the user can choose to display or stream the video or graphic files, respectively, from the desktop or from the web log.

Invitation tool 412 allows a user to invite guest viewers to a social networking site. In one exemplary embodiment, the user can allow other users to request guest access, can limit the content or areas to which a guest viewer has access, or can impose other controls on guest access.

In one exemplary embodiment, the personal virtual desktop is under the control of the user. If the personal virtual desktop is made public, the user can act as an administrator and retain sole control over the configuration tools.

In another exemplary embodiment, a user can repeatedly join the social networking website and configure one or more personal virtual desktops for their use. A user can access the social networking website using a web browser, then create and save a personal virtual desktop for future access.

The personal virtual desktop can be persistent to the user. The configuration of the personal virtual desktop can be defined and controlled by use of the tools listed above. Once created, a reference identification to the personal virtual desktop can be stored locally as data by its user so that the personal virtual desktop could be used to recreate functionality within the personal virtual desktop.

The reference identification stored as data locally by the user and the controlling configuration of the personal virtual desktop can persist so that the personal virtual desktop that that has been customized and configured by the user would be loaded instead of, or in addition to the main page of the social networking website each time the main page of the social networking website is accessed.

The process of joining the social networking website and the creation of a personal virtual desktop by an anonymous user can create an identity to be used and provide verifiable personal user identification and contact information.

The user can be provided with the ability to use one or more of the set of tools described above which are made available for inclusion into the personal virtual desktop that provide the personal virtual desktop with functionality including the creation of web-based interactive personal virtual desktops. The personal virtual desktops can be configurable through the use of the tools described above where each tool can be used to create one aspect of the functions made available on the personal virtual desktop or the configuration of the personal virtual desktop.

Though the invention has been described with respect to a specific preferred embodiment, many variations and modifications will become apparent to those skilled in the art upon reading the present application. For example, if the product/service is specialized, such as a custom made bicycle, the maker of the custom made bicycle may send the potential buyer a questionnaire which will assist the maker of the bicycle in putting together a bicycle fit to the user's body and riding habits. It is therefore the intention that the appended claims be interpreted as broadly as possible in view of the prior art to include all such variations and modifications.

What is claimed is:

1. A system for sharing search results, comprising:
a chat room region adapted to allow real-time communication between a plurality of users;
a search result region adapted to receive a search term from one of the users, and display search results related to the search term;
a selection device adapted to select the search result region and drag the search result region into a chat room region in order to share the search results with one or more of the plurality of users.

2. The system for sharing search results of claim 1, wherein the chat room region contains a chat utility.

3. The system for sharing search results of claim 1, wherein the chat room region contains an instant message utility.

4. The system for sharing search results of claim 1, wherein the chat room region contains an e-mail utility.

5. The system for sharing search results of claim 1, wherein the search result region contains a search engine interface.

6. The system of claim 1, wherein said user receives an inducement to purchase said product/service in return for receiving a more complete description of said product or service.

7. The system of claim 1 further comprising a customizable personal virtual desktop wherein said personal virtual desktop may be configured by use of one or more of an ownership tool, a public and private tool, a membership tool, a blog tool, an invitation tool and a video and graphic tool.

8. A method for sharing search results, comprising:
selecting a search result region on a first user's screen;
dragging the search result region into a chat room region on the first user's screen;
launching a search result region on a second user's screen; and
populating the search result region on the second user's screen with the search results contained in the search result region of the first user's screen.

9. The method of claim 8, further comprising sending a message to the chat room region of the second user's screen to specify that the search results were sent by the first user.

10. The method of claim 8, wherein selected search results from the search result region of the first user's screen are dragged into the chat room region of the first user's screen.

11. The method of claim 8, wherein the chat room region contains a chat room application.

12. The method of claim 8, wherein the chat room region contains an instant messaging application.

13. The method of claim 8, wherein the chat room region contains an e-mail application.

14. The method of claim 8, wherein the search result region contains a search engine interface.
